(19) United States
(12) Patent Application Publication
(10) Pub. No.: US 2015/0213026 A1
(43) Pub. Date: Jul. 30, 2015

(54) METHOD FOR PROVIDING PERSONALIZED CONTENT

(71) Applicant: Sitecore Corporation A/S, Kobenhavn V (DK)

(72) Inventors: Michael SEIFERT, Kobenhavn V (DK); Lars Birkholm PETERSEN, Kobenhavn V (DK)

(73) Assignee: Sitecore Corporation A/S, Kobenhavn V (DK)

(21) Appl. No.: 14/608,888

(22) Filed: Jan. 29, 2015

Related U.S. Application Data
(60) Provisional application No. 61/933,530, filed on Jan. 30, 2014.

(51) Int. Cl. G06F 17/30; H04L 29/08

(52) U.S. Cl. CPC G06F 17/3053; H04L 67/22

(57) ABSTRACT

The impact of personalized content on visitor behaviour is tested by dividing visitors belonging to a segment of visitors into first and second subsets. Visitors of the first subset receive personalized content and visitors of the second subset receive default content. The behaviour of the visitors is monitored and compared between the subsets, and the personalization rules are adjusted according to the outcome of the test. The test is initiated automatically by a content provider module.

### FIELD OF THE INVENTION

The present invention relates to a method for providing personalized content, e.g. web content, such as content of websites, content in apps, etc., to visitors, via a content provider module, e.g. including a content management system (CMS).

### BACKGROUND OF THE INVENTION

When providing content, such as web content, to visitors, it is sometimes assumed that various types of visitors may be interested in various types of content. Therefore some components or elements of the provided content may be varied in accordance with the type of visitor to which the content is provided. This is sometimes referred to as ‘personalization’. The object of providing personalized content to the visitors is to ensure that the provided content corresponds to the desires of the individual visitor, thereby maintaining the interest of the visitor, prolonging the interaction with the visitor and/or encouraging a desired behaviour of the visitor.

It is desirable to investigate whether or not personalization of content has the desired effect. Various attempts to achieve this have previously been suggested.

US 2008/0275980 A1 discloses a method and a system for testing variations of website content useful to optimize website visitor conversions. Test variations of website content are integrated with web analytics platforms so that website variations can be tracked and analysed within web analytics reporting systems. A reverse proxy server is used for introducing page variations on existing website content without needing to modify the existing web server. Thereby it is possible to test a number of website variations and access such data from within web analytics platforms.

US 2006/0064339 A1 discloses a method and a system for conducting internet marketing experiments. The system may include an experiment design engine to construct an experiment over designated webpages. A distributed experiment control engine may execute the experiment design constructed by the design engine. Desired user behaviour in response to each possible experimental path is recorded. An experiment analysis engine may analyse experiments, and an optimization engine may determine which experimental path is optimum upon conducting the experiment.

US 2012/0151329 A1 discloses a method in which a request to render a control content is intercepted by a client application as it is being served from a content source. Based on predetermined criteria, the control content is replaced with replacement content, such as an alternative version of the control content differing from the control content on one or more alternative elements. Different versions of the webpages can be distributed to different groups of users based on selectable criteria. Based on gathered statistics it can be determined which versions of the webpages provide the best results.

Common to the methods and systems described in the prior art is that the test of the effect of the personalized content must be planned and performed consciously by the author of the content, and prior to launching the personalized content.

### DESCRIPTION OF THE INVENTION

It is an object of embodiments of the invention to provide a method for providing personalized content, in which a test of the effect of the personalized content is performed automatically and without the intervention of a content author.

It is a further object of embodiments of the invention to provide a method for providing personalized content, in which the effect of the personalized content is continuously tested.

It is an even further object of embodiments of the invention to provide a method for providing personalized content, in which the effect of the personalized content can be optimized, without requiring that a separate test period is run prior to launching the personalized content.

The invention provides a method for providing personalized content to visitors via a content provider module, the method comprising the steps of:
defining one or more segments of visitors,
defining personalization rules which, for each defined segment of visitors, defines personalized content to be provided to visitors belonging to said segment, and which defines default content to be provided to visitors which do not belong to any of the defined segments of visitors,
providing content to a plurality of visitors in accordance with the personalization rules,
the content provider module performing a test regarding at least one segment of visitors by providing personalized content to a first subset of visitors and default content to a second subset of visitors, the first and second subsets of visitors forming part of the segment(s) of visitors being tested; monitoring visitor behaviour, including actions and/or navigations performed by the visitors; and comparing the visitor behaviour of visitors of the first subset of visitors to the visitor behaviour of visitors of the second subset of visitors, thereby obtaining an outcome of the test,
the content provider module recording the outcome of the test, and
adjusting the personalization rules in response to the outcome of the test.

The method of the invention is a method for providing personalized content to visitors. The content being provided could, e.g., be web content, i.e. content provided from a web database, such as content of websites, content in apps, content of kiosks etc. As an alternative, the content being provided may be provided from other kinds of databases, such as third party repositories, e.g. CRM, ERP, social site data, point of sale, call centres, etc. The content being provided is personalized, i.e. the specific content being provided is selected to match the expected desires of the visitor receiving the content.

In the present context the term ‘visitor’ should be interpreted to mean a person who is receiving the content, e.g. viewing the content and/or interacting with the content. In the case that the content is content of a website, the visitor is a person who visits the website, e.g. viewing content of the website, navigating webpages of the website and/or interacting with components of the website.

The content is provided via a content provider module. In the present context the term ‘content provider module’ should be interpreted to mean a module which is capable of providing the content to visitors. The content may be provided via a communication network, such as the Internet. As an alternative, the content may be provided via direct interaction between the visitor and the content provider module, e.g. by the visitor accessing the content provider module via a kiosk.

In the method of the invention, one or more segments of visitors is/are initially defined. In the present context the term ‘segment of visitors’ should be interpreted to mean a group of visitors, where the visitors belonging to the group or segment share one or more characteristics. It is assumed that this or these characteristic(s) indicate(s) that the visitors prefer to receive specific content. This will be described further below.

For instance, three segments of visitors may be defined as:

1. Visitors having signed up for a newsletter.

2. Female visitors.

3. Visitors who are interested in stamps from the fifties.

It is not ruled out that a visitor may belong to two or more of the defined segments. In the example above, a female visitor who has signed up for a newsletter and who is interested in stamps from the fifties belongs to all of the three defined segments. In this case a given visitor may be assigned to all of the segments where the visitor matches the characteristics of the segment, or the visitor may be assigned to one of the segments in accordance with specified rules. This will be described further below.

Once the one or more segments of visitors have been defined, a remaining group of visitors is also defined as the group of visitors who do not match the characteristics of any of the defined segments. In the example above, a male visitor who has not signed up for a newsletter, and who is not interested in stamps from the fifties, will belong to the remaining group of visitors. In the case that only one segment of visitors is defined, the visitors will in reality be divided into two groups, i.e. the visitors belonging to the segment, i.e. the visitors matching the characteristics of the segment, and visitors not belonging to the segment.

Next, personalization rules are defined. For each defined segment, the personalization rules define personalized content to be provided to visitors belonging to that segment. The personalization rules further define default content to be provided to visitors who do not belong to any of the defined segments, i.e. to visitors belonging to the remaining group of visitors.

The personalization rules may be defined manually, e.g. by an editor. As an alternative, the personalization rules may be run automatically by the system.

The personalized content is selected in such a manner that it is assumed that personalized content of a specific segment of visitors will appeal to the visitors belonging to that specific segment of visitors, i.e. the personalized content is specifically directed towards a specific segment of visitors. The default content, on the other hand, is not directed towards a specific segment of visitors, but may instead be selected so as to be appealing to most of the expected visitors.

When the personalization rules have been defined, content is provided to a plurality of visitors in accordance with the personalization rules. Thus, in the case that a given visitor is recognised as belonging to a specific segment of visitors, then the content provided to this visitor is the personalized content which is defined for that segment of visitors by the personalization rules. On the other hand, if a given visitor is not recognised as belonging to any of the defined segments of visitors, then the default content is provided to the visitor.

While content is provided to the plurality of visitors, the content provider module performs a test regarding at least one segment of visitors. The test is performed by selecting a segment of visitors, and dividing the visitors belonging to this segment of visitors into two subsets of visitors. One subset of visitors is provided with the personalized content which is defined for the segment of visitors by the personalization rules, and the other subset of visitors is provided with the default content. The subsets of visitors may be of equal size, i.e. approximately half of the visitors belonging to the selected segment of visitors may be assigned to the first subset of visitors, and approximately half of the visitors belonging to the selected segment of visitors may be assigned to the second subset of visitors. As an alternative, the visitors may be distributed among the subsets of visitors in a different manner, e.g. assigning 10% of the visitors to the first subset of visitors and 90% of the visitors to the second subset of visitors, or vice versa. Then the visitor behaviour of the visitors belonging to the segment of visitors being tested is monitored. This includes monitoring actions and/or navigations performed by the visitors. Finally, the visitor behaviour of the visitors of the first subset of visitors is compared to the visitor behaviour of the visitors of the second subset of visitors, and thereby an outcome of the test is obtained.

Thus, the outcome of the test reflects whether or not it has an impact on the visitor behaviour, if a visitor belonging to a given segment of visitors is provided with the personalized content defined by the personalization rules, or with the default content. In particular, the outcome of the test may reveal whether or not the personalized content selected for a given segment of visitors encourages the visitors belonging to that segment of visitors to behave in a manner which the content provider desires. Furthermore, in the case that the default content actually encourages the visitors to behave in a desired manner to a greater extent than the personalized content, then this may also be revealed by the outcome of the test. Accordingly, the outcome of the test reveals whether or not the selected personalized content is appropriate with respect to achieving goals set by the content provider with respect to the behaviour of the visitors receiving content via the content provider module.

The content provider module then records the outcome of the test. Finally, the personalization rules are adjusted in response to the outcome of the test. It should be noted that the step of adjusting the personalization rules may include deciding to maintain the personalization rules, i.e. performing no changes to the rules. This could advantageously be the case, if the outcome of the test reveals that the personalized content results in a desired behaviour of visitors of a tested segment of visitors to a great extent.

Adjustments to the personalization rules may, alternatively or additionally, include deciding that personalized content shall no longer be provided to visitors of a segment of visitors which was tested, and that the default content must instead be provided to future visitors belonging to this segment of visitors. This could, e.g., be the case if the outcome of the test reveals that providing the personalized content to the tested segment of visitors has no or a negative effect on the behaviour of the visitors, as compared to providing the default content to the visitors. Alternatively, adjustments to the personalization rules may include adjusting the personalized content for a segment of visitors. In this case personalized content will still be provided to visitors belonging to this segment of visitors, but the selected personalized content is changed. This could, e.g., be the case if the outcome of the test reveals that providing personalized content to the visitors of a tested segment of visitors has a positive effect on the behaviour of the visitors, as compared to providing default content to the visitors, but that the effect is not as pronounced as desired.

Alternatively or additionally, adjustments to the personalization rules may include adjusting one or more criteria used for determining whether or not a given visitor belongs to a given segment of visitors.

Thus, according to the method of the invention, personalized content is defined and launched, i.e. it is provided to actual visitors, and the impact of the personalization on the behaviour of the visitors is tested while the personalized content is provided to the visitors. Thus, a content author only has to define the segments of visitors and define personalization rules, i.e. select personalized content which he or she believes will be appealing to visitors belonging to the respective segments of visitors. The test is then automatically and silently initiated and performed by the content provider module, and the test is performed with respect to actual visitors. Thus, performing the test requires no separate action from the content author, and it may even be performed without the content author being aware that a test is being performed. Adjustments to the personalization rules may only be performed if it turns out that the initially defined personalization rules are not having the desired impact on the visitor behaviour.

The content may comprise one or more parts of one or more webpages. According to this embodiment, the visitors will typically be visitors visiting a website including the one or more webpages. In the present context the term ‘website’ should be interpreted to mean a collection of related webpages, images, videos or other digital assets being addressed relative to a common Uniform Resource Locator (URL). The webpages of the website may advantageously be designed, presented and linked together to form a logical information resource and/or transaction initiation function.

According to this embodiment, the content may be an entire webpage. As an alternative, the content may be only a part of a webpage, e.g. a component of the webpage, an element of the webpage, or a field of the webpage.

For instance, one component on a webpage may be personalized, or two or more components on a webpage may be personalized. In the case that two or more components on a webpage are personalized, the components may be tested separately, or they may be tested simultaneously.

Using the example defining three segments of visitors described above, the personalization rules could be as follows.

1. If the visitor has signed up for a newsletter, show “What's your interest” content.

2. If the visitor is female, show “Get the boots” content.

3. If the visitor is interested in stamps from the 50's, show “Why not buy the 51 Stamps collection” content.

4. If the visitor is none of the above, show Default content (e.g. “Get the yellow 50's dress now” content).

Thus, in a prior art scenario, a visitor who is categorized as belonging to the ‘female’ segment of visitors will only be presented with the “Get the Boots” content, and never the “Get the yellow 50's dress now” content. However the “Get the yellow 50's dress now” content may in fact be more appealing to female visitors. However, according to the method of the present invention, a test is automatically initiated and performed by the content provider module. As described above, the test includes presenting some of the female visitors with the personalized content, i.e. with the “Get the Boots” contents, and some of the female visitors with the default content, i.e. with the “Get the yellow 50's dress now” content, and comparing the visitor behaviour of the visitors who received the personalized content to the visitor behaviour of the visitors who received the default content. Thereby it is revealed whether the “Get the Boots” content encourages the female visitors to behave in a manner which the content provider desires, or whether the “Get the yellow 50's dress now” content is in fact better at encouraging the female visitors to behave in a desired manner. Furthermore, this is done automatically by the content provider module, and the content author does not have to perform any separate actions in this regard.

The step of performing a test may be performed simultaneously for two or more personalized parts of at least one webpage. According to this embodiment, two or more parts of a webpage are selected for presenting personalized content to visitors. When performing the test, it is selected, for each visitor belonging to a segment of visitors, whether the personalized content or the default content should be presented to the visitor, for all of these parts of the website. For instance, a first subset of visitors may receive the personalized content for all of the parts of the webpage, while a second subset of visitors may receive the default content for all of the parts of the webpage. As an alternative, the segment of visitors may be divided into a first and a second subset of visitors for each of the parts of the webpage. In this case a given visitor may receive personalized content for some parts of the webpage and default content for other parts of the webpage. Separate tests may then be performed as described above for each of the parts of the webpage.

Alternatively or additionally, the content may comprise one or more parts of an app. This could, e.g., be an opening message the user sees when he or she opens the app. Depending on which segment the user belongs to, he or she could be exposed to the personalized content and tested against default content simultaneously. As another alternative, the content may comprise instore content or content of kiosks. As an example, this could be a Point of sale screen, where the customers see personalized content, based on the purchase they are about to buy, that is tested simultaneously with default content, that could be joining the loyalty club.

The content provider module may comprise a content management system (CMS). In the present context the term ‘content management system’, or ‘CMS’, should be interpreted to mean a system, which allows a content author to create and edit content, such as content of a website or content of an app. According to this embodiment, the content provider module may advantageously be of a kind which provides websites or apps to visitors via a communication network.

The method may further comprise the step of repeating the step of performing a test. According to this embodiment, the test is repeated, e.g. after some time has been allowed to lapse, or in response to content and/or personalization rules being changed. This allows the personalized content to be repeatedly or continuously tested, and thereby it will quickly be revealed if the personalized content is not having the desired effect. When repeating the test, the same segment(s) of visitors which was/were originally tested may be selected, or one or more segments of visitors which have not previously been tested may be selected.

The step of performing a test may comprise the steps of:
for each visitor, monitoring navigations and/or actions performed by the visitor, while accumulating value points in accordance with content viewed by the visitor and actions performed by the visitor, and in accordance with predefined value point settings associated with the content, thereby obtaining an accumulated value point score for the visitor,
for each visitor, storing the accumulated value point score along with information regarding whether the visitor belongs to the first subset of visitors or to the second subset of visitors, and
comparing the accumulated value point scores obtained by the visitors of the first subset of visitors to the accumulated value point scores obtained by the visitors of the second subset of visitors.

According to this embodiment, information regarding the visitor behaviour of the visitors of the selected segments of visitors is obtained in the following manner.

When a visitor receives requested content, including personalized content or default content, depending on whether the visitor belongs to the first subset of visitors or the second subset of visitors, the navigations and/or actions performed by the visitor are monitored. Simultaneously, value points are accumulated in accordance with content viewed by the visitor, including content which does not form part of the tested content, and actions performed by the visitor. Value point settings have previously been associated with the content, preferably in a manner which reflects how valuable it is to the content provider that a visitor views a specific piece of content or performs a specific action. The value points are accumulated in accordance with the value point settings. As a result, an accumulated value point score is obtained for each visit. The value points may, e.g., be associated with previously defined goal conversions. As an alternative to collecting value points as described above, the visitor behaviour may be monitored in order to obtain information regarding goal conversions, click through rates, click patterns, etc.

For each visitor, the accumulated value point score is stored along with information regarding whether the visitor belongs to the first subset of visitors or to the second subset of visitors, i.e. whether the visitor received the personalized content or the default content.

Finally, the accumulated value point scores obtained by visitors of the first subset of visitors are compared to the accumulated value point scores obtained by visitors of the second subset of visitors. Thereby the comparison reveals whether the accumulated value points ‘collected’ by visitors belonging to the first subset of visitors are greater than the accumulated value points ‘collected’ by the visitors belonging to the second subset of visitors, and thereby whether the behaviour of the visitors belonging to the first subset of visitors is more or less valuable than the behaviour of the visitors belonging to the second subset of visitors. In other words, the comparison reveals whether the personalized content or the default content made the visitors behave in a desired manner to the greatest extent.

The comparison may advantageously include comparing average accumulated value point scores per visit or per visitor. In this case, the compared values may be regarded as corresponding to the average efficiency of the visits or visitors.

The method may further comprise the step of, for each visitor, recording information regarding which segment of visitors the visitor belongs to. This information may, e.g., be used for investigating whether personalized content selected for one segment of visitors appears to be efficient, while personalized content selected of another segment of visitors appears not to be efficient. Thus, a comparison across various segments of visitors may be performed.

The step of performing a test may further comprise, for each visitor, registering click patterns performed by the visitor. Click patterns reflect at least part of the behaviour of a visitor. It may be desirable that the visitors perform certain clicks, possibly in a specified sequence, during a visit. Registering click patterns performed by the visitors may therefore provide valuable information regarding whether or not a given visitor behaves in a desired manner. Alternatively or additionally, the step of performing a test may comprise, for each visitor, registering click rates and/or interactions, such as filling in and submitting a web form.

The step of performing a test may be performed simultaneously with respect to two or more segments of visitors. According to this embodiment, two or more segments are tested simultaneously. Thereby a larger group of visitors is tested simultaneously, and a result regarding all of the segments of visitors can be reached faster than was the case if each segment of visitors was tested separately and sequentially.

The method may further comprise the step of the content provider module communicating the outcome of the test to a content author, in the case that the outcome of the test reveals that personalized content affects visitor behaviour in an undesired manner. This may, e.g., be in the form of a warning to the content author, e.g. informing him or her that the latest change in personalized content for a given segment of visitors appears to be detrimental. This will prompt the content author to act, e.g. by deciding that visitors belonging to the segment of visitors in question shall in the future receive the default content instead of personalized content. As an alternative, the content author may adjust the personalized content provided to the visitors belonging to the segment of visitors in questions.

Thus, the step of adjusting the personalization rules may be performed by the content author, and the step of adjusting the personalization rules may comprise determining whether or not personalized content shall be provided to future visitors belonging to a given segment of visitors.

As an alternative, the step of adjusting the personalization rules may be performed automatically by the content provider module. This may, e.g., be the case if the outcome of the test reveals that the personalized content has the desired effect on the behaviour of the visitors of the segment of visitors being tested. The content provider module may then simply decide to provide the personalized content to all future visitors belonging to this segment of visitors. Thus, the content author may, in this case, never realize that a test was performed.

The method may comprise the step of defining two or more segments of visitors. According to this embodiment, the visitors are divided into at least three groups, i.e. visitors belonging to a first segment of visitors, visitors belonging to a second segment of visitors and visitors who do not belong to any of the defined segments of visitors. It should be noted that a third, a fourth, a fifth, and even further segments of visitors may be defined.

The segments of visitors may be ordered, and a visitor may be assigned to the segment of visitors having the highest order, where the visitor matches defined criteria for belonging to the segment of visitors. The ordering, or ranking, of the segments of visitors may be selected in such a manner that the segment having the highest order or ranking is the one which is defined by characteristics of the visitors which are regarded as having the highest impact on the behaviour of the visitors, in response to the selected personalized content.

A given visitor may fulfil the criteria for belonging to several segments of visitors. In this case it must be determined which of these segments of visitors the visitor shall be assigned to. According to this embodiment, the segment of visitor having the highest order or ranking is selected.

In the example above, a female visitor who has signed up for a newsletter, and who is interested in stamps from the fifties fulfils the criteria for being assigned to all of the three defined segments of visitors. The segments may be ordered in such a manner that the “female” segment has the highest order, the “signed up for newsletter” segment is ordered second, and the “interested in stamps from the fifties” has the lowest order. In this case the visitor described above will be assigned to the “female” segment of visitors. This ordering of the segments of visitors may be selected because it is assumed that the fact that the visitor is a female will affect the behaviour and the preferences of the visitor more than the fact that the visitor signed up for a newsletter. Similarly, it is assumed that the fact that the visitor signed up for a newsletter affects the behaviour and preferences of the visitor more than the fact that the visitor is interested in stamps from the fifties.

In the example above, a male visitor who has signed up for a newsletter, and who is interested in stamps from the fifties will be assigned to the “signed up for newsletter” segment of visitors.

Obviously, a visitor who only fulfils the criteria for belonging to one of the defined segments of visitors will be assigned to this segment of visitors, and visitors who do not fulfil the criteria for belonging to any of the segments of visitors will not be assigned to a segment of visitors, and will receive the default content.

As another example, a first segment of visitors may be “Germans” and a second segment of visitors may be “Europeans”. In this case, a German visitor is also a European visitor. Therefore it will make most sense to give the “German” segment of visitors a higher order or ranking than the “European” segment of visitors. Thereby all German visitors will be assigned to the “German” segment of visitors, and all European visitors, who are not German, will be assigned to the “European” segment of visitors.

As an alternative to defining two or more segments of visitors, only one segment of visitors may be defined. This has already been described above.

The step of defining personalization rules may be performed by one or more content authors, via a user interface.

The work flow of the method may advantageously be as follows. Initially, a content author defines segments of visitors, including rules and criteria determining when a visitor should be regarded as belonging to a given segment of visitors. This is done via the user interface. Subsequently or simultaneously, the content author creates and/or modifies content, also via the user interface. This includes defining which parts of the content to be personalized, which personalized content should be provided to which segments of visitors, as well as defining default content to be provided to visitors who do not belong to any of the defined segments of visitors. The personalized content is created and/or modified in such a manner that the content author believes that the personalized content will be more appealing to the visitors belonging to the respective segments of visitors than the default content.

Once the segments of visitors have been defined and the personalization rules, including the personalized content and the default content, have been defined, the content provider module provides the content to visitors requesting it, in accordance with the personalization rules. That is, if it is determined that a given visitor belongs to a given segment of visitors, then the personalized content corresponding to that segment of visitors is provided to the visitor. However, independently of the content author, the content provider module will initiate a test, as described above, with respect to one or more of the segments of visitors. This is done without any active action of the content author, and the content author may not even know that a test is initiated.

One or more segments of visitors may be deselected in the sense that the content author may decide that some of the segments of visitors should not be subject to a test. For instance, the content author may, upfront, decide that a given segment of visitors should not be tested, at least for a limited period of time. This may, e.g., be because the content author knows that the default content will not be appealing or relevant to the visitors belonging to this segment of visitors, and that the personalized content, on the other hand, will be appealing and relevant. In this case the content author may simply inform the content provider module that this segment of visitors should not be tested, and in response thereto the content provider module will simply refrain from testing the segment of visitors. Alternatively or additionally, the content provider module may inform the content author each time a segment of visitors has been selected for testing. This will allow the content author to intervene in order to prevent a given segment of visitors from being tested. Thus, in this case the content provider module will only perform a scheduled test if the content author approves that a selected segment of visitors is tested.

In the case that the outcome of the test reveals that the personalized content corresponding to a tested segment of visitors is in fact having a desired effect on the visitor behaviour of the visitors belonging to that segment of visitors, then the content provider module may simply decide to keep the current personalization rules unchanged, i.e. to provide the personalized content to all future visitors belonging to that segment of visitors. If, on the other hand, the outcome of the test reveals that the default content results in a more desired visitor behaviour than the personalized content, or if the outcome of the test reveals that there is no significant difference between the visitor behaviour of the visitors receiving the personalized content and the visitor behaviour of the visitors receiving the default content, then the content provider module may communicate this to the content author.

When the content author receives such information, he or she can perform required adjustments to the personalization rules in order to improve the visitor behaviour of future visitors. This may, e.g., include deciding to provide default content to future visitors of a given segment of visitors. Or adjusting the personalized content in the attempt to provide personalized content which is more appealing to the visitors belonging to the tested segment of visitors than the previous personalized content.

The method may further comprise the steps of:
each content author estimating a test result based on changes made to content by said content author, and
for each content author, comparing the estimated test result to an actual test result.

According to this embodiment, two or more content authors may have access to creating and editing the content being provided by the content provider module, via the user interface. Each time a content author creates new content or edits existing content, he or she will estimate which impact the new or edited content will have on the visitor behaviour. When a test relating to the new or edited content has been completed, the estimate provided by the content author is compared to the actual outcome of the test. Thereby it is possible to monitor which content authors are best at estimating the impact of the changes they perform on the content, as well as which content authors are best at creating content which results in a desired visitor behaviour.

Thus, the method may further comprise the step of generating a score report reflecting the comparison between estimated test results and actual test results.

### BRIEF DESCRIPTION OF THE DRAWINGS

The invention will now be described in further detail with reference to the accompanying drawings in which

FIG. 1 is a diagrammatic view of a system for performing a method according to an embodiment of the invention,

FIG. 2 is a diagrammatic view of a content provider module used for performing a method according to an embodiment of the invention,

FIG. 3 is a flow diagram illustrating a method according to a first embodiment of the invention, and

FIG. 4 is a flow diagram illustrating a method according to a second embodiment of the invention.

### DETAILED DESCRIPTION OF THE DRAWINGS

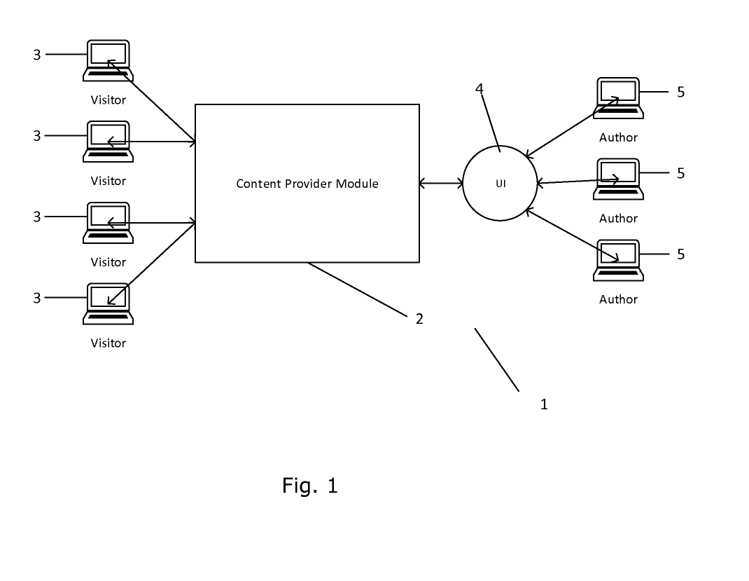

FIG. 1 is a diagrammatic view of a system 1 for performing a method according to an embodiment of the invention. The system 1 comprises a content provider module 2 arranged to provide content to a plurality of visitors via a plurality of visitor devices 3. The content is provided in accordance with a set of personalization rules which have previously been defined by a content author.

The content provider module 2 is further arranged to communicate with a plurality of content authors, via a user interface 4 and a plurality of content author devices 5.

In FIG. 1 the visitor devices 3 and the content author devices 5 are illustrated as personal computers (PC), but it should be noted that the client devices 3 and the content author devices 5 could alternatively be cell phones, tablets, TVs, or any other suitable kind of device allowing a visitor or a content author to access the content provider module 2, via a communication network.

The content authors access the content provider module 2 via the user interface 4 in order to create or edit content to be provided to visitors by the content provider module 2. Furthermore, the content authors can define segments of visitors and personalization rules, via the user interface 4. The personalization rules define which personalized content to be provided to visitors belonging to the various segments of visitors.

The visitors access the content provider module 2 in order to request content which is provided by the content provider module 2. The content may, e.g., be in the form of one or more webpages of a website, an app, or any other suitable kind of content which can be distributed via a communication network, such as the Internet. Upon request, the content provider module 2 provides the requested content to a visitor, via the corresponding visitor device 3. The content provided to the visitors is in accordance with the personalization rules which were previously defined by the content authors.

The content provider module 2 is further adapted to perform a test in the manner described above, where some visitors of a segment of visitors receive personalized content while other visitors of the same segment of visitors receive default content. The behaviour of the visitors is then monitored, during the visit, and the behaviour of the visitors who received the personalized content is compared to the behaviour of the visitors who received the default content. In response to the outcome of the test, the personalization rules may be adjusted in order to obtain that future visitors behave in a desired manner to a greater extent. This will be described in further detail below.

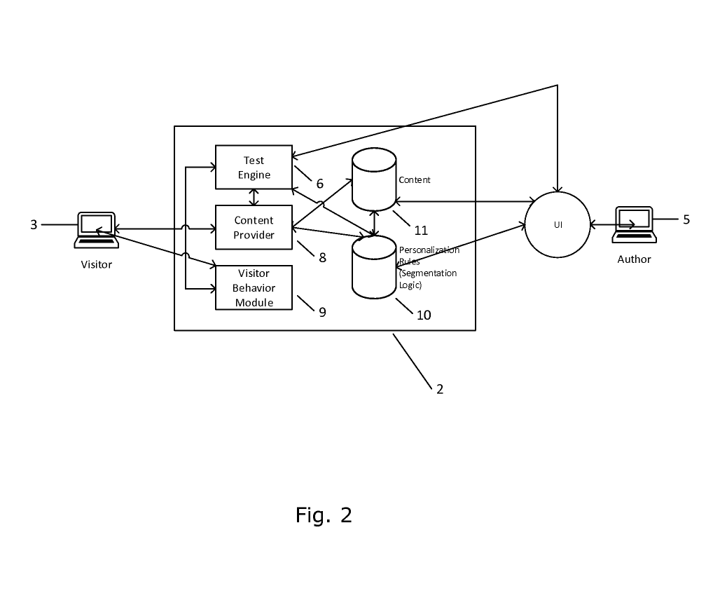

FIG. 2 is a diagrammatic view of a content provider module 2 used for performing a method according to an embodiment of the invention. The content provider module 2 may, e.g., form part of the system of FIG. 1. The content provider module 2 comprises a test engine 6, a content provider 8, and a visitor behaviour module 9. The content provider module 2 further comprises a personalization rules database 10 and a content database 11. In the personalization rules database 10 personalization rules are stored, and in the content database 11 content to be provided to visitors is stored.

A content author can access the personalization rules database 10 and the content database 11, via a content author device 5. This allows the content author to create, edit and delete content stored in the content database 11. It also allows the content author to create, adjust or delete personalization rules stored in the personalization rules database 10. The access to the personalization database 10 and the content database 11 may take place via a user interface, as illustrated in FIG. 1. Alternatively, the content author may access the databases 10, 11 directly.

Thus, a content author may initially contact the content database 11 in order to create content to be provided to visitors. The content may include web content, such as webpages of a website, components of webpages, apps, etc. The content is created in such a manner that some of the content is personalized, i.e. some of the content is variable, depending on the visitor requesting the content. The personalized content may, e.g., be one or more entire webpages or one or more components, elements or parts of a webpage or an app. For instance, some of the personalized content may be an advertisement, colour of a component or button, positioning of various components within a webpage, etc. The content further includes default content to be provided to visitors who do not belong to any defined segment of visitors.

Furthermore, the content author may contact the personalization rules database 10 in order to create or adjust personalization rules. The personalization rules define one or more segments of visitors, including criteria to be fulfilled in order to conclude that a given visitor belongs to a given segment of visitors. Furthermore, in the case that two or more segments of visitors are defined, the personalization rules may advantageously define an ordering of the segments of visitors in order to allow visitors fulfilling the criteria for belonging to two or more of the segments of visitors, to be assigned to only one of the segments of visitors.

The personalization rules further define rules specifying which personalized content to be provided to visitors belonging to which segment of visitors. The personalized content for a given segment of visitors is selected in such a manner that it is assumed that the personalized content will be more appealing to the visitors belonging to the segment of visitors than the default content. Thus, when creating the content and the personalization rules, the content author attempts to ensure that all visitors requesting content are provided with relevant and appealing content.

A visitor may access the content provider 8, via a visitor device 3, in order to request content. When the content provider 8 receives a request for content, it initially determines whether or not the visitor fulfils the criteria for belonging to one or more segments of visitors. To this end the content provider 8 consults the personalization rules database 10 in order to extract the criteria determining whether or not a visitor belongs to a given segment of visitors, and possibly any ordering of the segments of visitors. As a result, the visitor content provider 8 either assigns the visitor to a segment of visitors or determines that the visitor does not belong to any of the defined segments of visitors.

In the case that the visitor has been assigned to a segment of visitors, the content provider 8 then contacts the personalization rules database 10 in order to extract personalization rules regarding the segment of visitors which the visitor has been assigned to. Then the content provider 8 contacts the content database 11 and requests content in accordance with the extracted personalization rules. In the case that the content provider 8 determines that the visitor does not belong to any of the defined segments of visitors, the content provider 8 does not contact the personalization rules database 10, but contacts the content database 11 directly, requesting default content.

Finally, the content provider 8 provides the content to the visitor, via the visitor device 3.

At any time the test engine 6 may decide to perform a test. To this end the test engine 6 selects a segment of visitors to be tested. It should be noted that two or more segments of visitors could be selected simultaneously, but for simplicity the situation where only one segment of visitors is selected is described in the following. The test engine 6 may contact the personalization rules database 10 in order to obtain information regarding which segments of visitors are defined, to thereby allow the test engine 6 to select one of them. As described above, one or more segments of visitors may be deselected by the content author, either initially and upfront, or in response to a request from the content provider module 2, e.g. from the test engine 6. In this case the test engine 6 will refrain from performing tests with respect to the deselected segment(s) of visitors.

If the selected segment of visitors is not deselected by the content author, the test engine 6 then provides information to the content provider 8 that a test is to be initiated with respect to the selected segment of visitors. When a visitor belonging to the selected segment of visitors subsequently contacts the content provider 8 in order to request content, the content provider 8 assigns the visitor to a first subset of visitors or to a second subset of visitors. This may be done randomly, and for instance approximately half of the visitors are assigned to the first subset of visitors and half of the visitors are assigned to the second subset of visitors, although a different distribution of the visitors among the subsets of visitors is not ruled out, e.g. 10% of the visitors being assigned to the first subset of visitors and 90% of the visitors being assigned to the second subset of visitors.

When the content provider 8 requests content from the content database 11, it requests personalized content for the visitors belonging to the first subset of visitors and default content for the visitors belonging to the second subset of visitors.

During the visits, the visitor behaviour module 9 monitors the behaviour of the visitors of the selected segment of visitors. This may, e.g., include monitoring navigations performed by the visitors, value points collected by the visitors, actions performed by the visitors, click patterns performed by the visitors, click through rates, etc. Information regarding the behaviour of each visitor and information regarding which subset of visitors the visitor belongs to is provided from the visitor behaviour module 9 to the test engine 6, where the information is recorded.

This is continued until a sufficient number of visitors belonging to the selected segment of visitors have requested and received content from the content provider 8. In the present context the term ‘sufficient number of visitors’ should be interpreted to mean a number of visitor which allows meaningful statistical analysis to be performed on the obtained information regarding the behaviour of the visitors.

Then the test engine compares the behaviour of the visitors belonging to the first subset of visitors to the behaviour of the visitors belonging to the second subset of visitors. This may, e.g., include comparing average collected value points per visit, and/or comparing click patterns performed by the visitors. Based on the comparison, the test engine 6 produces an outcome of the test. The outcome reveals whether or not there is a difference between the behaviour of the visitors belonging to the first subset of visitors, i.e. the visitors who received the personalized content, and the visitors belonging to the second subset of visitors, i.e. the visitors who received the default content. In the case that there is a difference, the outcome of the test further reveals whether the visitors belonging to the first subset of visitors or the visitors belonging to the second subset of visitors behaved most in a desired manner. Thereby the outcome reveals whether or not providing personalized content to the visitors of the selected segment of visitors has the desired effect in terms of encouraging the visitors to behave in a desired manner.

The outcome of the test may be communicated from the test engine 6 to the content author, via the content author device 5. For instance, if the outcome of the test reveals that the personalized content is not having a desired effect, this may be communicated to the content author. In response, the content author can adjust the personalization rules and/or the personalized content in an attempt to provide content to future visitors belonging to the selected segment of visitors, which to a greater extent encourages the visitors to behave in a desired manner.

Alternatively or additionally, the test engine 6 may contact the personalization rules database 10 directly in response to the outcome of the test, in order to perform minor adjustments to the personalization rules, or in order to confirm existing personalization rules. For instance, if the outcome of the test reveals that the personalized content is having a large positive impact on the behaviour of the visitors belonging to the selected segment of visitors, the test engine 6 may simply confirm to the personalization rules database 10 that the current personalization rules relating to the selected segment of visitors shall be maintained. In this case the content author is not notified, and he or she may never know that a test has been performed. It is, however, not ruled out, that even in this case a report is generated for the content author.

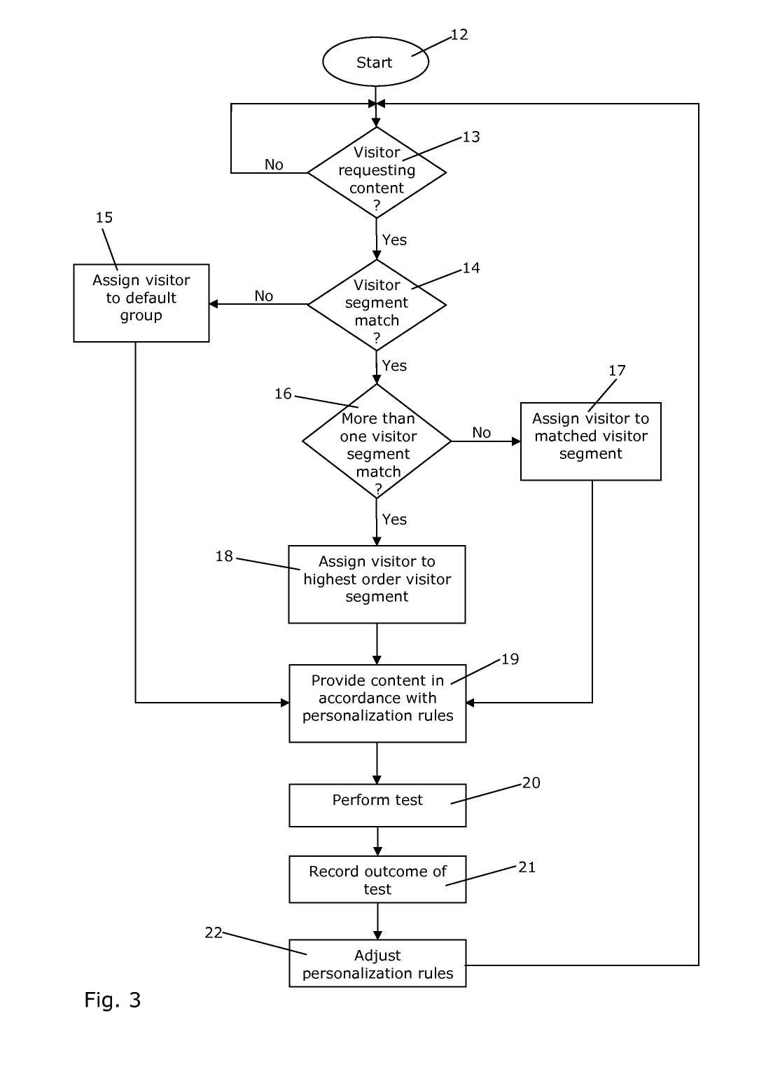

FIG. 3 is a flow diagram illustrating a method according to a first embodiment of the invention. The method may, e.g. be performed using the system of FIG. 1 and/or the content provider module of FIG. 2. The process is started at step 12. At step 13 it is investigated whether or not a visitor has requested content. If this is not the case, the process is returned to step 13 for continued monitoring for visitors.

If step 13 reveals that a visitor has requested content, the process is forwarded to step 14, where it is investigated whether or not there is a visitor segment match. This should be interpreted to mean that it is investigated whether or not the visitor fulfils the criteria for belonging to one or more previously defined segments of visitors. If this is not the case, the process is forwarded to step 15, where the visitor is assigned to a default group, i.e. to a group of visitors who shall receive default content.

If step 14 reveals that there is a visitor segment match, i.e. that the visitor fulfils the criteria for belonging to one or more segments of visitors, the process is forwarded to step 16, where it is investigated whether or not there is more than one visitor segment match, i.e. whether or not the visitor fulfils the criteria for belonging to more than one predefined segments of visitors. If this is not the case, the process is forwarded to step 17, where the visitor is assigned to the matched visitor segment, i.e. the visitor is assigned to the only segment of visitors, where the visitor fulfils the criteria for belonging to the segment of visitors.

If step 16 reveals that there is more than one visitor segment match, i.e. that the visitor fulfils the criteria for belonging to more than one segment of visitors, the process is forwarded to step 18. At step 18 the visitor is assigned to the segment of visitors having the highest order, where the visitor fulfils the criteria for belonging to the segment of visitors. The ordering of the segments of visitors has been defined previously.

From steps 15, 17 and 18 the process is forwarded to step 19, where content is provided to the visitors in accordance with previously defined personalization rules. Thus, the visitors who have been assigned to a segment of visitors receive personalized content which is specific for each of the defined segments of visitors. The visitors who have not been assigned to a segment of visitors receive default content.

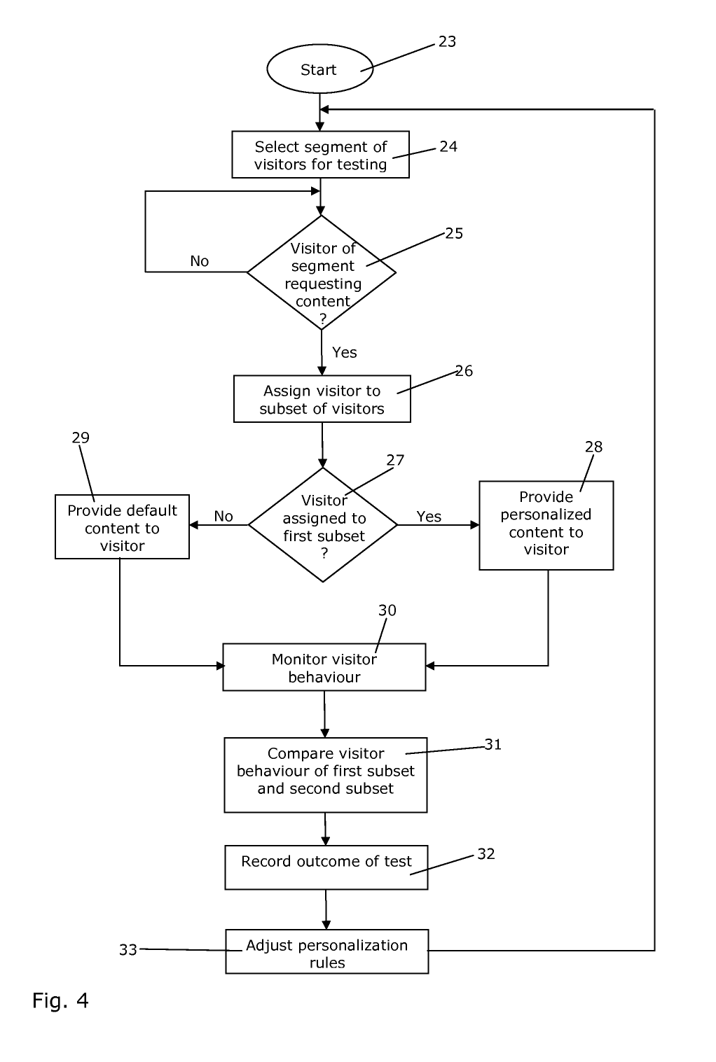

At step 20 a test is performed, e.g. in the manner which will be described below with reference to FIG. 4. In any event, for one or more of the predefined segments of visitors, the visitors are divided into a first subset of visitors and a second subset of visitors. The visitors of the first subset of visitors receive the personalized content related to the segment of visitors, and the visitors of the second subset of visitors receive the default content. The behaviour of the visitors is then monitored, and when a sufficient number of visitors have received content, the behaviour of the visitors of the first subset of visitors is compared to the behaviour of the visitors of the second subset of visitor, thereby obtaining an outcome of the test. The outcome reveals whether or not the personalized content succeeds in encouraging the visitors to behave in a desired manner, as described above.

At step 21 the outcome of the test is recorded, and at step 22 the personalization rules are adjusted in accordance with the outcome of the test. This may be done automatically, or it may be performed by a content author after the outcome of the test has been communicated to him or her. Adjusting the personalization rules should also be interpreted to include maintaining the personalization rules, which may be advantageous if it turns out that the personalized content to a great extent encourages the visitors to behave in a desired manner. Finally, the process is returned to step 13.

FIG. 4 is a flow diagram illustrating a method according to a second embodiment of the invention. The method may, e.g. be performed using the system of FIG. 1 and/or the content provider module of FIG. 2. The process is started at step 23. At step 24 a segment of visitors is selected for testing. As described above, this step may include investigating whether or not the selected segment of visitors has been deselected by the content author, and therefore should not be tested. This could, e.g., be done by consulting information which was previously provided by the content author. Alternatively or additionally, it could be done by the content provider module contacting the content author, asking him or her whether or not the selected segment of visitors can be tested. In the case that it turns out that the selected segment of visitors has been deselected by the content author, the content provider module will refrain from performing the test. Instead another segment of visitors is selected.

At step 25 it is investigated whether or not a visitor belonging to the selected segment of visitors has requested content. If this is not the case, the process is returned to step 25 for continued monitoring for visitors.

If step 25 reveals that a visitor belonging to the selected segment of visitors has requested content, the process is forwarded to step 26, where the visitor is assigned to a subset of visitors. The visitors of the selected segment of visitors are thereby divided into a first subset of visitors and a second subset of visitors. The visitors may be divided among the first and second subsets of visitors in an equal manner, i.e. approximately half of the visitors being assigned to the first subset of visitors and half of the visitors being assigned to the second subset of visitors. However, another distribution of the visitors should not be ruled out, as described above.

At step 27 it is investigated whether or not the visitor was assigned to the first subset of visitors. If this is the case, the process is forwarded to step 28, where personalized content, in accordance with the selected segment of visitors, is provided to the visitor.

If step 27 reveals that the visitor was not assigned to the first subset of visitors, then it is concluded that the visitor was assigned to the second subset of visitors, and the process is forwarded to step 29. At step 29 default content is provided to the visitor.

From step 28 and step 29 the process is forwarded to step 30, where the behaviour of the visitors is monitored. This may, e.g., include collecting value points and/or monitoring click patterns, as described above.

At step 31 the behaviour of the visitors belonging to the first subset of visitors is compared to the behaviour of the visitors belonging to the second subset of visitors, thereby obtaining an outcome of the test.

At step 32 the outcome of the test is recorded, and at step 33 the personalization rules are adjusted in accordance with the outcome of the test, in the manner described above with reference to FIG. 3.

1. A method for providing personalized content to visitors via a content provider module, the method comprising the steps of:
defining one or more segments of visitors,
defining personalization rules which, for each defined segment of visitors, defines personalized content to be provided to visitors belonging to said segment, and which defines default content to be provided to visitors which do not belong to any of the defined segments of visitors,
providing content to a plurality of visitors in accordance with the personalization rules,
the content provider module performing a test regarding at least one segment of visitors by providing personalized content to a first subset of visitors and default content to a second subset of visitors, the first and second subsets of visitors forming part of the segment(s) of visitors being tested; monitoring visitor behaviour, including actions and/or navigations performed by the visitors; and comparing the visitor behaviour of visitors of the first subset of visitors to the visitor behaviour of visitors of the second subset of visitors, thereby obtaining an outcome of the test,
the content provider module recording the outcome of the test, and
adjusting the personalization rules in response to the outcome of the test.

2. The method according to claim 1, wherein the content comprises one or more parts of one or more webpages.

3. The method according to claim 2, wherein the step of performing a test is performed simultaneously for two or more personalized parts of at least one webpage.

4. The method according to claim 1, wherein the content comprises one or more parts of an app.

5. The method according to claim 1, wherein the content provider module comprises a content management system (CMS).

6. The method according to claim 1, further comprising the step of repeating the step of performing a test.

7. The method according to claim 1, wherein the step of performing a test comprises the steps of:
for each visitor, monitoring navigations and/or actions performed by the visitor, while accumulating value points in accordance with content viewed by the visitor and actions performed by the visitor, and in accordance with predefined value point settings associated with the content, thereby obtaining an accumulated value point score for the visitor,
for each visitor, storing the accumulated value point score along with information regarding whether the visitor belongs to the first subset of visitors or to the second subset of visitors, and
comparing the accumulated value point scores obtained by the visitors of the first subset of visitors to the accumulated value point scores obtained by the visitors of the second subset of visitors.

8. The method according to claim 1, further comprising the step of, for each visitor, recording information regarding which segment of visitors the visitor belongs to.

9. The method according to claim 1, wherein the step of performing a test further comprises, for each visitor, registering click patterns performed by the visitor.

10. The method according to claim 1, wherein the step of performing a test is performed simultaneously with respect to two or more segments of visitors.

11. The method according to claim 1, further comprising the step of the content provider module communicating the outcome of the test to a content author, in the case that the outcome of the test reveals that personalized content affects visitor behaviour in an undesired manner.

12. The method according to claim 11, wherein the step of adjusting the personalization rules is performed by the content author.

13. The method according to claim 12, wherein the step of adjusting the personalization rules comprises determining whether or not personalized content shall be provided to future visitors belonging to a given segment of visitors.

14. The method according to claim 1, the method comprising the step of defining two or more segments of visitors.

15. The method according to claim 14, wherein the segments of visitors are ordered, and wherein a visitor is assigned to the segment of visitors having the highest order, where the visitor matches defined criteria for belonging to the segment of visitors.

16. The method according to claim 1, wherein the step of defining personalization rules is performed by one or more content authors, via a user interface.

17. The method according to claim 16, further comprising the steps of:
each content author estimating a test result based on changes made to content by said content author, and
for each content author, comparing the estimated test result to an actual test result.

18. The method according to claim 17, further comprising the step of generating a score report reflecting the comparison between estimated test results and actual test results.
